(19) United States
(12) Patent Application Publication
(10) Pub. No.: US 2014/0310038 A1
(43) Pub. Date: Oct. 16, 2014

(54) PROJECT TRACKING

(71) Applicant: Claude RIVOIRON, Le Plessis Robinson (FR)

(72) Inventor: Claude RIVOIRON, Le Plessis Robinson (FR)

(21) Appl. No.: 14/247,821

(22) Filed: Apr. 8, 2014

(30) Foreign Application Priority Data
Apr. 11, 2013 (FR) 13 53261

(51) Int. Cl. G06Q 10/06

(52) U.S. Cl. CPC G06Q 10/0631
USPC 705/7.12

(57) ABSTRACT

A method of project tracking with a plurality of tasks, each task being associated with projected temporal data for the tasks, comprising, for a task,
(a) reception, from a user interface, of progress data for said task,
(b) calculation of updated temporal data for this task,
(c) display of a representation of the task taking into account said updated temporal data, and
(d) if association data establish a link between said task and at least one other task, for each of said at least one other task, calculation, for said other task, of the updated temporal data on the basis of said association data and updated temporal data for said task, display of a representation of this other task and reiteration of these steps so as to obtain an updated representation of all of the tasks of the project.

The invention relates to project tracking implemented by digital processing means, for example a computer, a smartphone, an onboard or offboard processor, or the like.

The reason is that it is important to organize and check the progression of a project because in fact any delays generally result in an increase in the overall cost of the project and/or in a lesser production quality, or even in the introduction of a risk. By way of example, for an aeronautical, naval, real-estate or other construction site, some tasks can be planned in summer because it is desirable for them to be performed under certain weather conditions: if the site falls behind and these tasks are performed in winter, there is an increased risk of failure. The project manager will therefore have to take a decision as regards awaiting better weather conditions, and therefore increase the delay further, or take the risk of performing the tasks in winter.

For a project involving several tasks, for example a site, a project for developing a new product or the like, it is known practice to use a piece of software at the start of a project to input a set of tasks with temporal data for each task, for example a start date and a duration, or else a start date and an end date for the task. The software may allow this set of tasks to be displayed, with, for each task, a location based on the temporal data corresponding to this task.

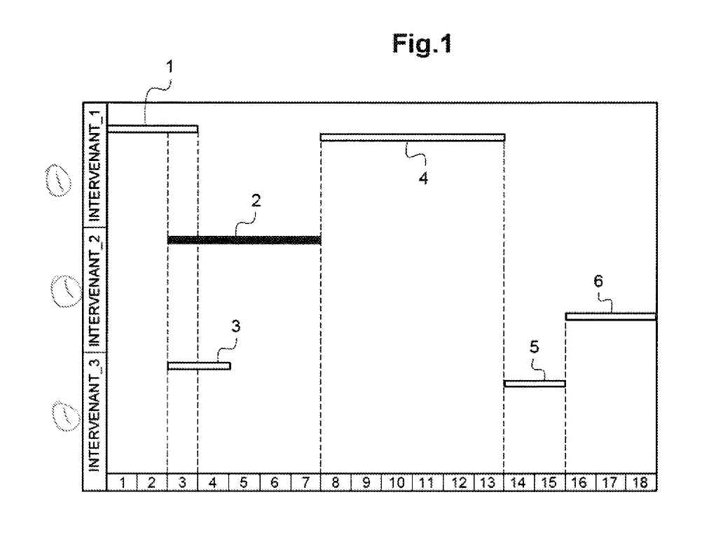

By way of example, the user can use a screen to visualize planning in two dimensions, one corresponding to the time, comprising a set of bars staggered to a greater or lesser extent according to the corresponding temporal data, of the type of planning shown in FIG. 1.

In the example in FIG. 1, a first bar 1 corresponds to a first task that needs to be performed by a first participant between a first and a third day from the start of a project.

When this first task 1 is sufficiently advanced, for example after two days, there is provision to start a second task, shown in this case by bar 2, and a third task, shown in this case by bar 3, these tasks needing to be performed by two other respective participants. When the second task, shown by bar 2, is finished, the first participant can then begin a fourth task shown by bar 4. When the fourth task is finished, the third participant can begin a fifth task shown by bar 5. And when this fifth task is finished, the second participant can begin a sixth task, shown here by bar 6.

Such forward planning can thus allow the user, for example a project manager or the like, to visualize all of the tasks and participants involved in the project, and thus to estimate an overall duration for completing the project.

In this example, it is envisaged that the project will thus be finished in 18 days.

However, the project may progress differently from the manner envisaged. By way of example, a task may start later or earlier than envisaged and/or take more or less time than envisaged.

It is known practice, in order to follow the progress of a project, to input progress data relating to a task, for example a percentage performed for this task, a number of days of delay in relation to the forward planning for this task, or the like, in the course of progression of this project. The software can thus allow the bar corresponding to the task affected by such a timing shift to be displayed using a different color.

By way of example, to return to the example in FIG. 1, if the second participant, who is notably responsible for performing the task corresponding to bar 2, does not start this task until after the fourth day, for example, and is unable to make up his delay, the user supervising the project can input, for example at the end of the sixth day, that the second task has still been performed only to 60%, for example, instead of the expected 80%.

Processing means then order bar 2, corresponding to the second task, to be displayed in a different color than the other bars 1, 3, 4, 5, 6. By way of example, bar 2 is displayed in a red color, whereas the other bars 1, 3, 4, 5, 6 are displayed using a green color.

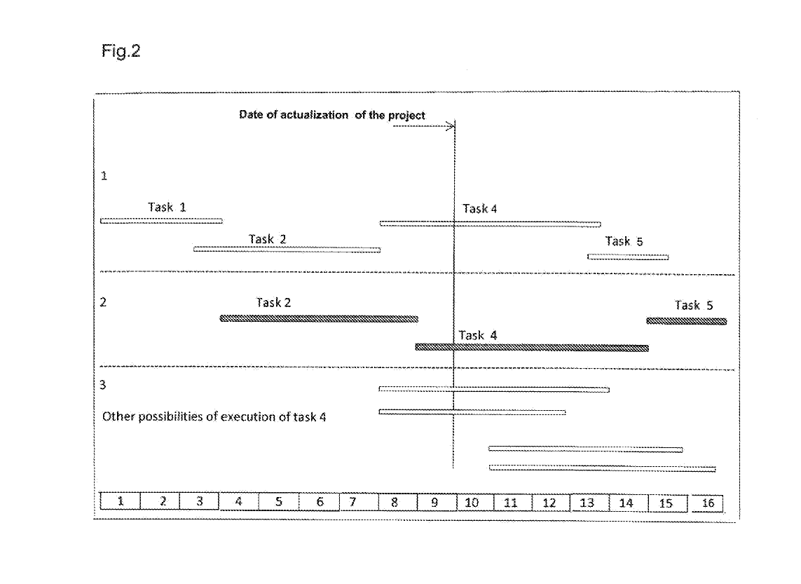

With reference to FIG. 2, task 2 has not been finished as envisaged on the 7^{th}, and its successor, task 4, has not been able to be begun on account of this delay, and has begun only on the 9^{th}. The tasks that follow task 4 will be shifted, downstream, by the same value.

For tracking the progression of a project, the consideration of the actual progress of the performance of the tasks as it is updated, owing to the noted delays, is not part of the scheme in which the projected data for the tasks and the ordering thereof would remain inalterable. FIG. 2 shows that, on the basis of the actual performance of the tasks in relation to their forecast, the input, step by step, of the progress data will be long and tricky in order to update an average large project.

There is a need for project tracking that allows better control of the time for performing the project. This may be crucial insofar as delays generally have a direct effect on the quality and/or cost of performance.

### SUMMARY OF THE INVENTION

In order to facilitate updating of a project and consequently management thereof at time control level, the text that follows will outline the various possibilities of the patent, namely on the following basis: by taking into account, during calculations, reality in relation to forecasts thereof and performing this update in two parts.

The calculations take the following into account:
for the period in the past that is concerned by the update, on a given date, the calculations for input of the actual progress of each of the tasks in the project will take into account their actual data rather than the projected data and ordering of said tasks (second step),
for the period to come after the update date, for all tasks that follow the tasks in progress, the projected ordering between the tasks will be preserved (first step).

The first step will show, for the future of the progression of the project, the consequences of delays in the past with a view to examining these consequences, in order to intervene so as to reduce some or all of them.

On the basis of the input of the progress of some selected tasks, those in progress, on a given date, the consequences of all delays that have occurred since the beginning of the project will be known immediately. It will be possible to visualize, on the tracked planning, for each of the tasks, the line for its projected and actual performance, its total delay.

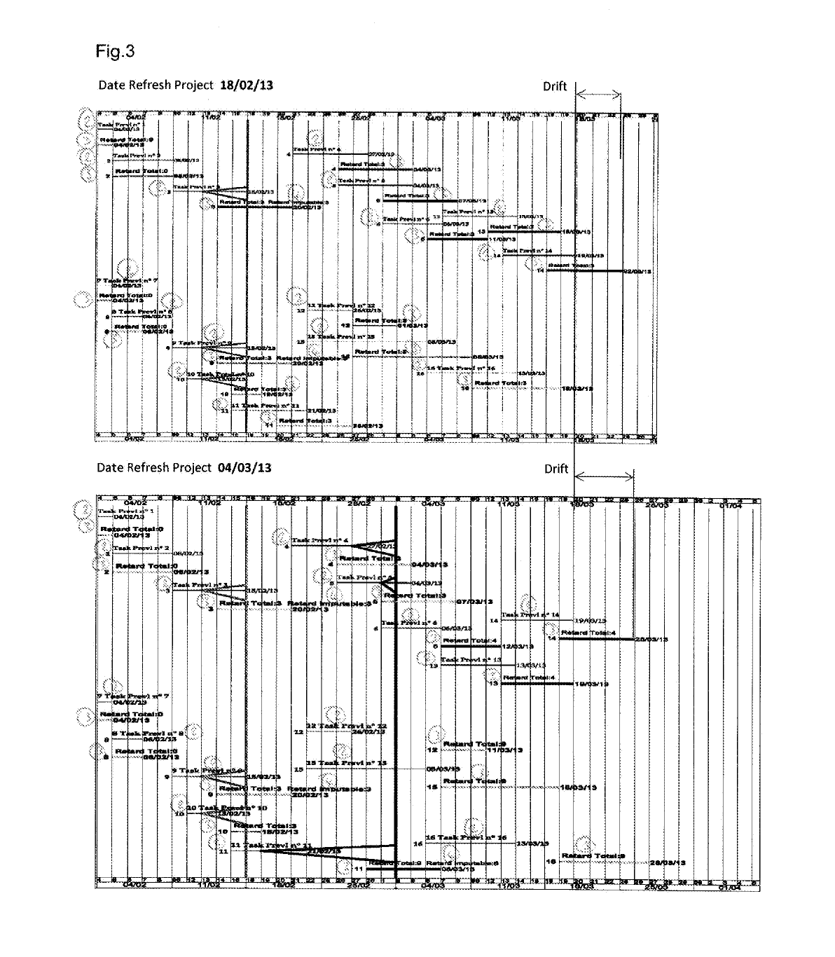

The actual end of its last task will be the end of the project, and thus the current drift for the project will be known (FIG. 3).

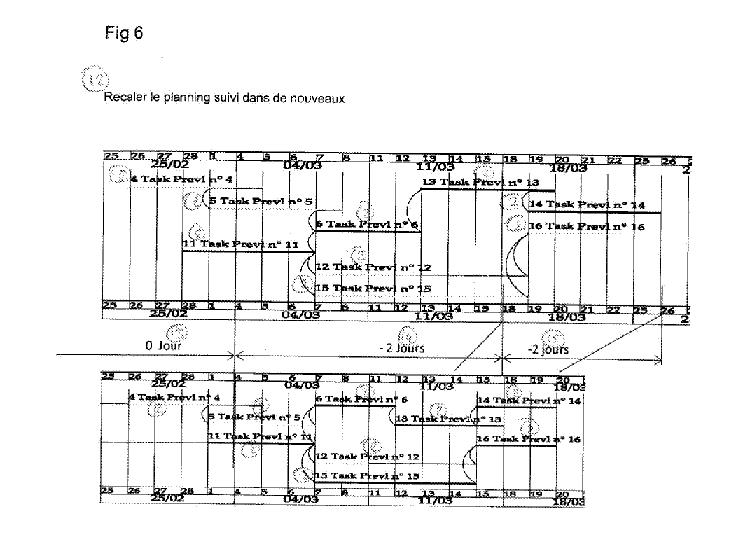

Since said drift is inadmissible, it will be possible to draw up new forward planning for the period that follows the last update, which will be part of new goals (FIG. 6).

The second step will allow a return to the past in order to ascribe the delays to the tasks in question. It will allow successive return to the past time of progression of the project so as to determine the actual performance of the predecessors to the tasks in progress at the time of the update, in order to determine for each of said tasks the portion of the total delay for which it is responsible: its ascribable delay.

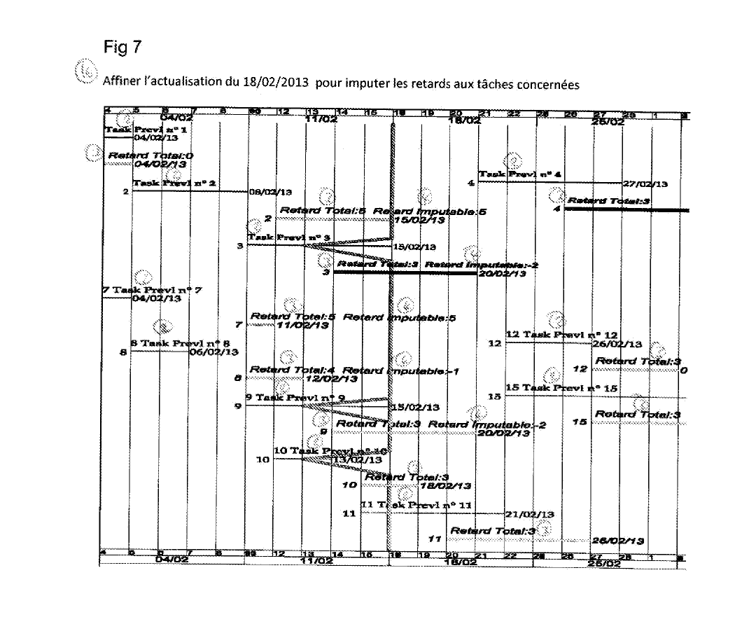

In the event of it being necessary to reduce a drift in a project, the consequences of direct delays and of the resources to reduce them will have costs, and it may be useful to establish a connection to this ascribing basis, which is difficult to dispute (FIG. 7).

For this new forward planning, for the period to come after the update date, it will again be possible to carry out this step again.

The document proposes a method of project tracking implemented by digital processing means, comprising:
storage of a set of task identifiers corresponding to respective tasks to be performed in a memory, with, for each task identifier, projected temporal data corresponding to this task identifier, and, for at least one task identifier, data associating a task with at least one other task establishing a link between the performance of this task and this at least one other task,
for at least one task identifier:
   (a) reception from a user interface, of the progress data of this task,
   (b) calculation of the updated temporal data on the basis of the progress data and the projected temporal data corresponding to this task,
   (c) display of a representation of the task taking into account this updated temporal data, and
   (d) if association data establish a link between this task and at least one other task, for each of these at least one other task:
      (i) calculation of the updated temporal data for this other task on the basis of this association data and updated temporal data for this task,
      (ii) display of a representation of this other task taking into account the updated temporal data for this other task,
      (iii) if association data establish a link between this other task and at least one other subsequent task, for each subsequent task, reiteration of steps (i), (ii) and (iii) in order to obtain an updated representation of all of the tasks of the project.

Thus, in the course of the progression of the project, the user can input progress data for one or more tasks, and following this input, can visualize an update for all of the tasks of the project.

The temporal projected or updated data may, by way of example, comprise a start date and a duration, or else a start date and an end date, or the like.

The association data make it possible to establish a link between the progress of a first task, for example the end of this first task, and the progress of a second task, for example the start of this second task. The invention is not in any way limited by the form of these association data. By way of example, they may involve a triplet comprising a pointer that allows identification of the second task, a first progress value for the first task, for example 80%, and a second progress value for the second task, for example 0%.

The progress data received from the user interface may, by way of example, comprise a percentage performed, or that remains to be performed, a number of days during which the task has been performed, a number of days that remain, or the like. The invention is also not limited by the form of the progress data.

The invention may thus allow better control of deadlines, cost and/or quality of the performance of a technical project.

The method may furthermore comprise a display step involving display, for each task, of a representation of the task on the basis of the projected temporal data for the task. Thus, the user is able to visualize all of the tasks as envisaged and all of the tasks as updated in the course of the progress of the project.

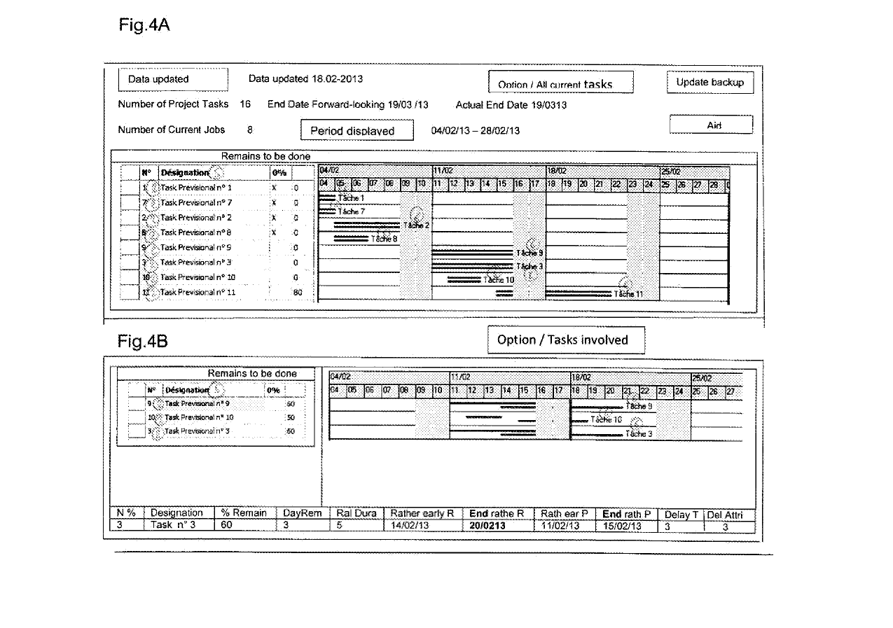

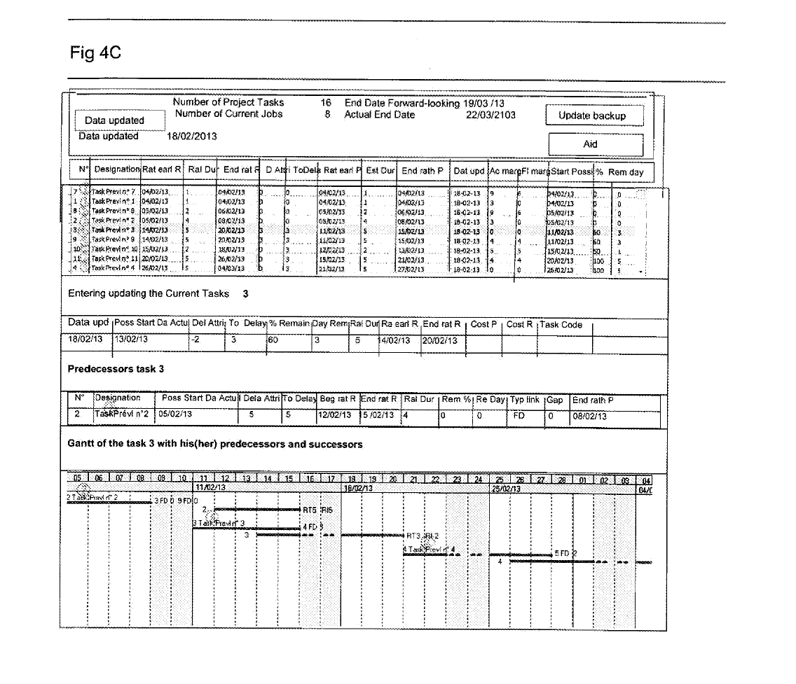

It will be possible to note that the user may just input a relatively small volume of progress data (those for the tasks in progress) and benefit from an update for the whole of the project. The update may thus be relatively quick to perform, FIGS. 4A-4B.

The invention is not limited by any form of the representations of the tasks.

By way of example, it will be possible to envisage displaying bars using different colors depending on whether a representation corresponding to projected temporal data (called projected tasks) or a representation corresponding to re-updated temporal data (called actual tasks) is involved.

The method described above thus implements task association data, and can provide a greater level of user convenience than a method in which the user would have to input progress data for each of the tasks. Such input would be relatively tricky because it would involve inputting the actual progress of all of the tasks. In fact, the user would thus have to know the date on which each of the tasks has been started, possibly finished, and what remains to be performed. This would involve very frequent, for example daily, checking of progress depending on the importance and the complexity of the project, which may be relatively restricting for the user. The method described above can allow relatively simple handling for the user, which can allow a person in charge of the project, for example a project manager for a site, to delegate this tracking to a less qualified person.

Furthermore, since this update is based on progress data that are generally observed on a date t by the user, the delays may be ascribed to the various tasks (FIG. 4C).

Advantageously and in a nonlimiting manner, it is possible to provide for calculation, for at least one task identifier, and, by way of example, for each task identifier, of a delay value ascribable to this task on the basis of the projected temporal data and captured progress data. By way of example, it is possible to calculate the delay that is ascribable to a task on the basis of the progress data that are input for any previous tasks associated with this task, any progress data input for this task, projected and updated temporal data corresponding to this task. Thus, for this task, it is possible to distinguish delays caused by delays in previous tasks from delays caused at the time of the actual performance of this task.

By way of example, if a given task begins with three days of delay in relation to the forward planning on account of a delay of three days for a previous task with which this given task is associated, and at a time of a progress input for this task, the user inputs a delay of five days, the method described above can allow a delay of two days to be ascribed to the person responsible for this given task, and a delay of three days to be ascribed to the person responsible for the previous task, by comparing the updated projected temporal data and the progress data.

The method described above can thus allow such and such a delay to be ascribed to such and such a provider, which may make it possible to simplify the determination of delay penalties for each of the providers and to limit the risk of dispute.

Advantageously and in a nonlimiting manner, the method may furthermore comprise:
reception, from the user interface, of desired temporal finish data corresponding to a given finish date, for example a finish date input by the user, or the like,
for each of the tasks for which the temporal data correspond to a time interval at least partly between this finish date and a given start date, for example a start date input by the user, recalculation of the adjusted temporal data on the basis of the desired finish date so that each of the tasks has adjusted temporal data corresponding to dates that are previous or equal to the desired finish date.

The method can thus allow the duration of the tasks to be adapted in order to better meet the deadlines.

More precisely, all the tasks in a given period can be compressed into a period of shorter duration.

By way of example, the finish data may correspond to a desired date for the end of the project, or to a desired data for the end of a given task, or else to a desired date for a given completion state for the project, for example 80%, or the like.

In one embodiment, the method may comprise:
calculation of a ratio between a desired duration, equal to a difference between the given start date and the desired finish date, and a current updated duration, equal to a difference between this start date and the current updated finish date,
for each of the tasks corresponding to the time interval between the start date and the current updated finish date, multiplication of a task duration value by this ratio in order to obtain adjusted temporal data.

The adjustment is thus relatively quick to make.

The invention is of course not limited to the form of adjustment implemented.

It is advantageously possible to provide for the interval of time between the start date and the current updated finish date to be divided into a plurality of intervals, and for adjusted temporal data to be calculated for each of the intervals in this plurality.

Advantageously and in a nonlimiting manner, the method may comprise a step involving establishing a critical path on the basis of the updated temporal data. By way of example, on the basis of the identifier of tasks for which the temporal data correspond to an updated finish date for the project, the various association data are used to return to an initial task, and a set of these tasks forms a critical path. During possible re-updating, a delay ascribed to such and such a task may bring about a change of critical path.

The invention is in no way limited by the form of the displayed representations. By way of example, it will be possible to provide for the delays to be displayed in the form of broken lines, for example between a point corresponding to the projected progress expected on the update date and a point corresponding to this date.

Advantageously and in a nonlimiting manner, the method may furthermore comprise a step involving storage of the link data to a memory that remembers information about the current tasks.

Thus, by means of a simple click, the user can have relatively easy access to this information relating to the tasks. It is thus possible to delegate supervision of the project to persons with less training on account of this free access to the information concerning the project.

Advantageously and in a nonlimiting manner, provision will be able to be made, at the end of the project, for storage, in a memory, of the updated temporal data for each of the tasks of the project. This set of updated temporal data will be able, upon comparison with the corresponding projected temporal data, to allow better understanding and better analysis of the actual progression of a project.

In particular, during the planning of a subsequent project, it will be possible to provide for simulation of an actual progression by applying the various delays corresponding to the updated temporal data for the previous project to the temporal data for the tasks of this subsequent project. Such experience feedback can thus assist better planning of subsequent projects. In other words, it will be possible to simulate the progression of a site so that the user is able to better envisage the progression of this site.

The invention furthermore relates to a device for project tracking comprising:
a memory that is capable of storing a set of task identifiers corresponding to respective tasks to be performed with, for each task identifier, projected temporal data corresponding to this task identifier, and, for at least one task identifier, data associating a task with at least one other task establishing a link between the performance of this task and this at least one other task,
reception means that are capable of receiving, for at least one task, progress data for this task, which data come from a user interface,
processing means for calculating updated temporal data on the basis of the received progress data and projected temporal data stored in the memory,
display means for controlling the display of a representation of the task taking into account the updated temporal data,
in which the processing means are designed so that, if association data establish a link between this task and at least one other task, they:
   (i) calculate, for this other task, updated temporal data on the basis of these association data and updated temporal data for this task,
   (ii) display a representation of this other task taking into account the updated temporal data for this other task,
   (iii) if association data establish a link between this other task and at least one other subsequent task, for each subsequent task, reiterate steps (i), (ii) and (iii) so as to obtain an updated representation of all of the tasks of the project.

By way of example, this device may comprise or be integrated in one or more processors. By way of example, the reception means may comprise an input port, an input pin or the like. By way of example, the processing means may comprise a processor core or the like.

By way of example, the display means, which are capable of sending a control signal, so as to display a representation of the task taking into account the updated temporal data, for example may comprise an output port, an output pin or the like.

The document furthermore proposes a computer program product comprising instructions for carrying out the steps of the method described above when this program is executed by digital signal processing means, for example a processor.

The invention will be better understood with reference to the figures, which illustrate nonlimiting embodiments.

FIG. 1 shows a screen display example on a user terminal, through application of a method of the type known from the prior art in order to determine the projected performance of a project.

FIG. 2 schematically shows that a step-by-step update is long and not very easy to perform when it is necessary to successively take all the actual progresses of the tasks, which the invention will permit, however: quickly knowing at any moment the consequences of the delays that have occurred allows intervention as soon as possible so as to see how to reduce them.

FIG. 3 shows a screen display example on a user terminal, after first and second updates, through application of a method according to an embodiment of the invention.

FIGS. 4A, 4B and 4C show various windows displayed on a screen during the application of the method according to an embodiment of the invention. This method may make it possible to dispense with the step of step-by-step update and to quickly determine the drift in the project and, if necessary, to determine the ascribing of the delays to the tasks in question.

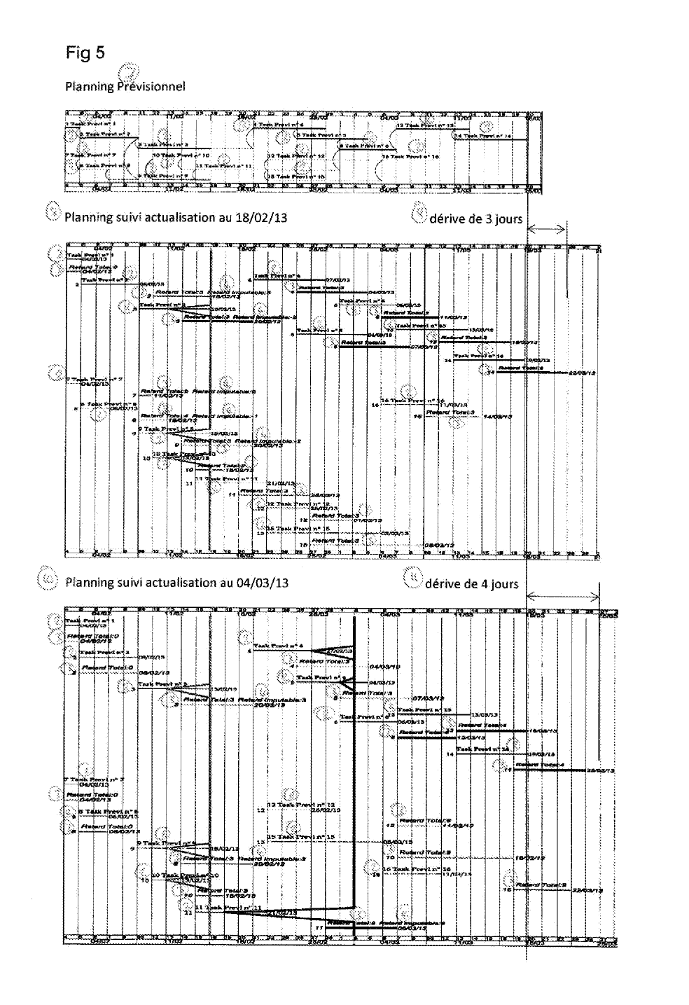

FIGS. 5 and 6 show how it is possible to take an update as a basis for visualizing the consequences of the delays and, if necessary, to obtain remedial planning.

FIG. 7 shows a screen display example on a user terminal for each of the tasks in question when a project is updated: the visual display of their projected and actual performance and the delay that can be ascribed to them.

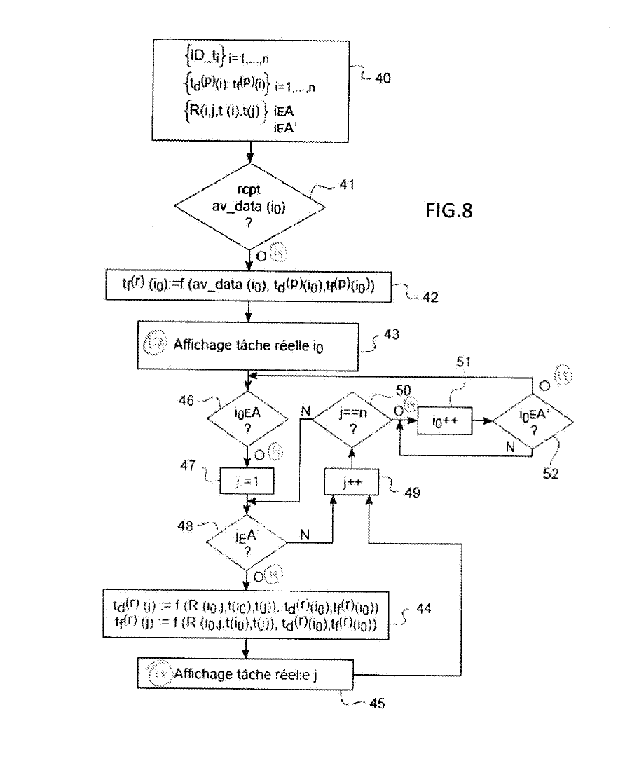

FIG. 8 is a flowchart for an example of a method according to an embodiment of the invention.

Identical references may be used to denote identical or similar objects from one figure to another.

FIG. 3 shows an example of planning as displayed on a screen, following the input of the various data relating to the envisaged tasks, and after an update.

At the start of the project, for each task, a task identifier, for example a number, and projected temporal data, for example a task start date and a duration, are input. Furthermore, association data allowing a task to be associated with one or more other tasks are input. By way of example, task no 2 can begin only when task no 1 is finished. Task no 12 begins only when task no 11 is finished. The various association data that are input make it possible to establish a critical path corresponding to a subset of tasks, such that a delay applied to one of these tasks brings about a delay over the whole project.

In FIG. 8, step 40 corresponds to this memory storage of the task identifiers ID_tᵢ for each task indexed i among a set of n tasks, of the projected temporal data for each task, for example a start date t_{d}^{(p)}(i) and an end date t_{f}^{(p)}(i), and of the data associating certain tasks with certain other tasks R(i,j,t(i),t(j)). A represents a subset of tasks, among the n tasks, with which other tasks have been associated, and A′ represents a subset of tasks, among the n tasks, which are indexed j and which are associated with tasks in the subset A.

In this embodiment, the tasks are shown in the form of bars, the length of which is proportional to the duration of the task. The bars are arranged at locations that correspond to the projected temporal data for the start of a task, and to a classification. The tasks classified as critical are shown using a first color, for example in red, while the tasks that are assessed as not being on the critical path are shown in blue. Alternatively, provision may be made for the bars of the critical tasks to be arranged next to one another so that the user is able to visualize the critical path (in bold) easily, as in the example in FIG. 3.

Thus, at the beginning of the project, the user is able to visualize planning for all of the tasks to be performed.

As the project progresses, the user is able to decide, on any update date and one chosen at his best convenience, to update some of the tasks in the planning. Based on the current date, the screen shows the tasks that need to be finished or that are in progress on this date.

If this is the first update, the user will see the tasks that need to be finished or are in progress between the start date of the project and the date of this first update. If this is a subsequent update, the user will see the tasks that need to be in progress or finished between the date of the previous update and the date of this current update.

By way of example, for an update date of Feb. 18, 2013, the user will be able to view on a screen a representation of tasks 1, 2, 3, 7, 8, 9, 10 and 11, as shown by FIG. 4 A.

The user can then tick the tasks to be hidden, for example in this case tasks 1, 7, 2, 8, that the user assesses to be finished. In other words, only the tasks in progress on the update date are kept.

The user inputs the progress of the tasks in progress that have remained on the screen, for example the user inputs values for durations that remain to be worked.

Advantageously, provision is furthermore made for the display of a table with, for each of these tasks, a table, of the type shown below, with progress data that have been input by the user.

| Task | % | Days | Actual | Actual | Actual | Projected | Projected | Total | Ascribable |
|---|---|---|---|---|---|---|---|---|---|
| N° | remaining | remaining | duration | start | end | start | end | delay | delay |
| 9 | 60 | 3 | 5 | 2/14 | 2/20 | 2/11 | 2/15 | 3 | 3 |

Thus, on Feb. 18, 2013, for example, the user considers there to be three days remaining to be worked for this task 9. The user just inputs the number 3 into the “days remaining” column and the date on which the task is effectively started, in this case February 14. On the basis of these input progress data, the system calculates:
the percentage of the task remaining to be performed, in this case 60%,
the actual duration of the task, in this case still five days,
an expected actual end date taking account of the date of the effective start and the number of days remaining, in this case February 20,
a total delay value and a delay value that can be ascribed to the project manager for this task, in this case three days.

The broken line in FIG. 3 allows the user to visualize these input delays on the screen. The method can allow the user to visualize the broken lines for all the updates already performed.

The invention is of course not limited by the form of these input progress data, and provision may be made for input of the actual end date to be furthermore proposed to the user. By way of example, the user can input the date Feb. 20, 2013 in a box corresponding to a column headed actual end date and in a row corresponding to task number 9.

The processing means then calculate a percentage of the task remaining to be performed, a total delay value, in this case three days, and an ascribable delay value, in this case three days.

With reference to FIG. 8, provision may be made that, if there is a task i₀ for which progress data av_data(i₀) are received, as shown by the test 41, then updated temporal data are calculated in a step 42 on the basis of these progress data and data remembered in step 40, for example an actual end date.

Furthermore, the method provides for the display of a representation of the task with its updated temporal data, as illustrated by step 43 in FIG. 8. The user is able to visualize, apart from the projected data shown here, for example in the form of red and blue bars depending on whether or not the tasks are critical, the actual data concerning the performance of the project, in the form of dark red and dark blue bars.

By way of example, if the user has input progress data relating to task 3 indicating that this task would be finished only in the evening of February 15, then the method furthermore displays an additional representation 31 of this task 3, as shown in FIG. 3.

This table furthermore displays the total delay value and the ascribable delay value, these two values being three days in this case.

In this example, association data R(3,4, t_{f}(3)+2, t_{d}(4)) establish a link between the end of the performance of task 3 and the start of performance of task 4. To be more precise, task 4 is supposed to begin two days after the completion of task 3.

The method comprises a step that involves calculation of the updated temporal data for this task 4, taking into account the progress data input for task 3.

This step is shown in FIG. 8 by the reference 44.

By way of example, the total delay value, in this case three days, is added to the start date for the projected task, in this case February 20, so that a start date updated to February 25 is obtained for this task 4.

A new bar is displayed for this task 4, with the updated temporal data (step 45 in FIG. 8).

Since this task 4 is moreover linked to task 5 by other association data—task 5 being supposed to begin two days before the completion of task 4—a new task start date is calculated for this task 5, with a shift of three days in relation to the projected start date.

In the same way, the input delays affecting tasks 3 and 9 are reflected in tasks 6, 10, 11 and 12.

In the flowchart in FIG. 8, steps 46 to 52 correspond to an implementation example that aims to cover the set of tasks associated with the task i₀ for which the user has input progress data, the set of tasks associated with this covered set, and so on gradually until all the tasks in question have been updated.

In the table in FIG. 4B, which displays only the tasks in progress, task 11 no longer appears since, on account of the shift by three days, this task will have a start date recalculated to February 20, that is to say after the current date.

However, the input data prevail over the projected data: if an actual end date of February 15 is input for task 10, the representation of this task is shifted, so as to extend between the marker corresponding to February 14 and the marker corresponding to February 15.

This input can be made in a table of the type below:

| Task | % | Days | Actual | Actual | Actual | Projected | Projected | Total | Ascribable |
|---|---|---|---|---|---|---|---|---|---|
| N° | remaining | remaining | duration | start | end | start | end | delay | delay |
| 10 | 0 | 0 | 2 | 2/14 | 2/15 | 2/12 | 2/13 | 2 | −1 |

The calculated ascribable delay value is negative because the delay has not been totally reflected in this task 10. On the contrary, this task 10 started on a date previous to the calculated start date.

With reference to FIG. 3, provision may advantageously be made for the update to be refined, so as to determine the ascribing of the delays to the tasks in question.

More precisely, data relating to task 2 have been input, which allows the ascribable delay value for task 3 to be reduced from five days to −2 days. The method may thus allow a delay value to be ascribed to each of the tasks. It may be possible to establish a connection between these responsibilities and the costs of the implementation means for adjusting the planning in time.

FIG. 4C shows a screen display example in the course of the refinement. The user has selected task 3, so that the table denoted “Input of the update for the task in progress” displays the data relating to this task 3. The method calculates a delay value, in this case three days because the task should have started on Feb. 11, 2013 whereas the start date input during the update is Feb. 14, 2013.

There is also displayed a table for each previous task directly associated with the selected task, in this case task 2. If the user inputs an actual end date of Feb. 15, 2013 for this task 2, the method calculates a total delay value of five days, since the projected end date is Feb. 8, 2013, and an ascribable delay value of five days also since the input progress data do not allow this delay to be ascribed to a previous task.

The method then recalculates the delays that can be ascribed to the subsequent tasks, on the basis of these progress data that have been input for the previous task or tasks. In this case, task 3 was in fact able to begin only on Feb. 18, 2013, since task 2 had not finished before this date. Now, this task 3 has an input start date of Feb. 14, 2013. Consequently, the delay value that can be ascribed to this task 3 is −2 days, on account of the five days that can be ascribed to task 2, but the total delay value for this task 3 continues to be three days. The following tasks, 4, 5, 6, are successively shifted by three days.

These steps involving refinement of the update, by inputting progress data concerning tasks that have already finished, thus make it possible to determine the ascribing of the delays to the tasks in question. This determination is based on comparisons between progress data that are input for the tasks in progress and progress data that are input for tasks that have already finished, by taking account of the association data between these various tasks.

Furthermore, the method can allow the critical path to be redefined in the course of performance of the project. By way of example, task 11, which is initially noncritical, may become a critical task if its delay results in a delay to the whole of the project.

By way of example, for a new update on Mar. 4, 2013 (FIG. 7), if the association data dictate that task 6 cannot begin until after the completion of task 11, and progress data, input on Mar. 5, 2013, following a total delay of nine days, six days of which can be ascribed thereto, bring about the calculation of this task 11, it becomes critical. Task 6 cannot begin until after the completion of task 11, that is to say on Mar. 7, 2013 if it ends on March 2012. On the other hand, the total delay is four days only, since initially task 11 had a projected margin of five days.

This delay of four days for task 6 is transferred to the tasks that are subsequent to it, and the last task 14 will finish on Mar. 25, 2013 instead of Mar. 19, 2013, or a drift of four working days.

It is moreover possible to carry out adjustment of the planning by simulation, FIG. 6.

The frequency of the updates may be based on the size and complexity of the project because it is always desirable to know the consequences of delays as soon as possible in order to be able to act and limit the consequences thereof.

Before the first update, the user can visualize planning in which the projected tasks and the corresponding actual tasks have identical locations. Then, following the input of the progress data, the user can visualize shifts between projected tasks and actual tasks.

The method can thus calculate a total delay value for the project, or drift.

Beforehand, it is possible to take into account the incidence of the delays that have occurred in the course of the progression of the project. In particular, the method can transform the data of actual performance dates for the tasks on the date of the last update into data for projected performance dates for the remaining period of the project (FIG. 6).

If the calculated drift is too large, it is possible to use the simulation procedure to obtain adjusted planning that corresponds to new aims.

For this, after having taken into account the various delays that have occurred, the method comprises a step of division of the remaining duration of the progression of the project into a plurality of homogeneous periods. A new start date and a new end date are then recalculated for each period by applying a coefficient to the duration of this period and shifting it so that it begins at the end of the new end date of the preceding period. In other words, all of the periods are contracted so that the end date of the project coincides with a desired end date. The tasks associated with a given period likewise see their start and end dates recalculated.

The user is then able to adapt the planning according to his knowledge of the project. By way of example, if the duration of a task cannot be reduced, or its performance start date moved forward, the user can impose temporal data for this task. This adjusted planning can thus be refined in order to obtain new forward planning for the period to come in the progression of the project after the last update date.

Advantageously, the data for the planning are coupled to a database that stores information relating to the tasks. The users can thus easily consult the information relating to a task, which may allow the management of all or part of the project to be delegated to persons who are less qualified than in the prior art.

Once the project has finished, all of the input progress data and the calculated data can be stored in memory, thus allowing experience feedback to be obtained that will be able to be turned to good account when drawing up forward planning for a subsequent project.

Initially, with screens 4A and 4B, the progress of the sole tasks in progress on a date will be input during an update. The visual display of the tracked planning that will show the consequences of the delays that have occurred since the start of the progression of the project will be obtained straight away. If the drift is unacceptable, it will be possible to obtain new forward planning that takes into account the noted delays, and then, through simulation, it will be possible to adjust said planning to new aims, FIGS. 5-6.

This described procedure will be able to be performed again on the adjusted forward planning that has just been set up.

In parallel, if required, it will be possible to perform the step of ascribing the delays to the tasks in question, FIG. 4C and FIG. 7. This is a virtually irrefutable basis that can be used during settlement.

1. A method of project tracking implemented by digital processing means, comprising:
storage (40) of a set of task identifiers ({ID_tᵢ}_{i=1, . . . , n}) corresponding to respective tasks to be performed in a memory, with, for each task identifier, projected temporal data (t_{d}^{(p)}(i), t_{f}^{(p)})(i)) corresponding to said task identifier, and, for at least one task identifier, data associating a task with at least one other task (R(i,j,t(i),t(j))) establishing a link between the performance of said task and said at least one other task,
for at least one task identifier:
(a) reception (41), from a user interface, of the progress data of said task (av_data(i₀)),
(b) calculation (42) of the updated temporal data (t_{f}^{(r)}(i₀)) on the basis of the progress data and the projected temporal data corresponding to said task,
(c) display (43) of a representation of the task taking into account said updated temporal data, and
(d) if association data establish a link between said task and at least one other task, for each of said at least one other task:
(i) calculation (44) of the updated temporal data for said other task on the basis of said association data and updated temporal data for said task,
(ii) display (45) of a representation of said other task taking into account the updated temporal data for said other task,
(iii) if association data establish a link between said other task and at least one other subsequent task, for each subsequent task, reiteration of steps (i), (ii) and (iii) in order to obtain an updated representation of all of the tasks of the project.

2. The method as claimed in claim 1, furthermore comprising a display step involving display, for each task, of a representation of said task on the basis of the projected temporal data for said task.

3. The method as claimed in claim 1, furthermore comprising calculation, for at least one task identifier, of a delay value ascribable to said task on the basis of the projected temporal data and captured progress data.

4. The method as claimed in claim 1, furthermore comprising:
reception, from the user interface, of desired temporal finish data corresponding to a given finish date,
for each of the tasks for which the temporal data correspond to a time interval at least partly between this finish date and a given start date, recalculation of the adjusted temporal data on the basis of the desired finish date so that each of the tasks has adjusted temporal data that are previous or equal to the desired finish date.

5. The method as claimed in claim 4, furthermore comprising:
calculation of a ratio between a desired duration, equal to a difference between the given start date and the desired finish date, and a current updated duration, equal to a difference between the given start date and a current updated finish date,
for each of the tasks corresponding to the time interval between the given start date and the current updated finish date, multiplication of a task duration value by this ratio in order to obtain adjusted temporal data.

6. The method as claimed in claim 1, in which the delays are displayed in the form of broken lines.

7. The method as claimed in claim 1, furthermore comprising
storage of the link data to a memory that remembers information about the current tasks.

8. The method as claimed in claim 1, furthermore comprising
storage of the updated temporal data for each of the tasks of the project in a memory so as to be able to simulate progression of a subsequent project.

9. A computer program product having instructions for performing the steps of the method as claimed in claim 1 when said program is executed by a processor.

10. A device for project tracking comprising:
a memory that is capable of storing a set of task identifiers corresponding to respective tasks to be performed with, for each task identifier, projected temporal data corresponding to said task identifier, and, for at least one task identifier, data associating a task with at least one other task establishing a link between the performance of said task and said at least one other task,
reception means that are capable of receiving, for at least one task, progress data for said task, which data come from a user interface,
processing means for calculating updated temporal data on the basis of the received progress data and projected temporal data stored in the memory,
display means for controlling the display of a representation of the task taking into account the updated temporal data,
in which the processing means are designed so that, if association data establish a link between this task and at least one other task, they:
(i) calculate, for this other task, updated temporal data on the basis of these association data and updated temporal data for this task,
(ii) display a representation of this other task taking into account the updated temporal data for this other task,
(iii) if association data establish a link between this other task and at least one other subsequent task, for each subsequent task, reiterate steps (i), (ii) and (iii) so as to obtain an updated representation of all of the tasks of the project.
